(19) United States
(12) Patent Application Publication
(10) Pub. No.: US 2015/0365573 A1
(43) Pub. Date: Dec. 17, 2015

(54) ELECTRONIC DEVICE CASE AND ELECTRONIC DEVICE HAVING THE SAME

(71) Applicant: Samsung Electronics Co., Ltd., Gyeonggi-do (KR)

(72) Inventors: Joo Hyung KIM, Seoul (KR); Woo Jung MOON, Seoul (KR); Woo Hyeok JEONG, Seoul (KR)

(21) Appl. No.: 14/740,787

(22) Filed: Jun. 16, 2015

(30) Foreign Application Priority Data
Jun. 16, 2014 (KR) 10-2014-0072707

(51) Int. Cl. H04N 5/225; H04N 5/232

(52) U.S. Cl. CPC H04N 5/2254; H04N 5/2252; H04N 5/2257; H04N 5/23209; H04B 5/0031

(57) ABSTRACT

An electronic device case is provided which includes a case part and a cover part. The case part includes a protrusion part protruding from one side thereof and a first through-hole through which a camera lens is exposed and which is disposed in the protrusion part. The cover part is detachably coupled to the protrusion part and includes a second through-hole disposed at a position corresponding to the first through-hole, where at least one of a lens and a filter is inserted into the second through-hole.

### PRIORITY

This application claims the priority under 35 U.S.C. §119(a) of a Korean Patent Application filed on Jun. 16, 2014, in the Korean Intellectual Property Office and assigned Serial No. 10-2014-0072707, the entire content of which is incorporated herein by reference.

### BACKGROUND

1. Field of Invention

The present invention relates generally to an electronic device case and an electronic device having the same.

2. Description of the Related Art

A conventional electronic device, such as a smart phone, may be equipped with a camera, and may additionally need a lens adaptor or a filter to change a viewing angle of the camera or to apply various effects to a picture.

In this case, a user may carry a lot of accessories. Furthermore, when coupled to the electronic device, a separate lens or filter may not be perfectly connected with the camera, thereby causing detachment of the lens and the like from the electronic device.

### SUMMARY

The present invention has been made to address at least the problems and/or disadvantages described above, and to provide at least the advantages described below.

Accordingly, an aspect of the present invention is to provide an electronic device case capable of covering a camera lens of an electronic device.

Another aspect of the present invention is to provide a cover into which a lens or filter, independent of a camera of an electronic device, is inserted.

Another aspect of the present invention is to provide an electronic device capable of automatically changing a setting of the electronic device based on a type of a lens or filter inserted in a cover that is coupled to a case.

In accordance with an aspect of the present invention, an electronic device case is provided. The electronic device case includes a case part and a cover part. The case part includes a protrusion part protruding from one side thereof and a first through-hole through which a camera lens is exposed and which is disposed in the protrusion part. The cover part is detachably coupled to the protrusion part and includes a second through-hole disposed at a position corresponding to the first through-hole, where at least one of a lens and a filter is inserted into the second through-hole.

In accordance with another aspect of the present invention, an electronic device is provided. The electronic device includes an electronic device case, a camera, an NFC module, and a control part. The electronic device case includes a case part and a cover part. The case part includes a protrusion part protruding from one side thereof and a first through-hole through which a camera lens is exposed and which is disposed in the protrusion part. The cover part is detachably coupled to the protrusion part. The cover part includes a second through-hole disposed at a position corresponding to the first through-hole, where at least one of a lens and a filter is inserted into the second through-hole. The NFC module is configured to read the NFC tag when connected to the electronic device case. The control part is configured to control an operation of the camera in response to the NFC tag information.

### BRIEF DESCRIPTION OF THE DRAWINGS

The above and other aspects, features, and advantages of certain embodiments of the present invention will be more apparent from the following description, taken in conjunction with the accompanying drawings, in which:

FIG. 1 is a perspective view of an electronic device including an electronic device case, according to an embodiment of the present invention;

FIG. 2 is an exploded view of an electronic device including an electronic device case, according to an embodiment of the present invention;

FIG. 3 is a perspective view of a case part of an electronic device case, according to an embodiment of the present invention;

FIG. 4 is a perspective view of a cover part of an electronic device case, according to an embodiment of the present invention;

FIG. 5 is a perspective view of an electronic device, according to an embodiment of the present invention;

FIG. 6 is a block diagram for illustrating transmission of data through an NFC tag to an electronic device, according to an embodiment of the present invention; and

FIG. 7 is a block diagram illustrating a configuration of an electronic device, according to an embodiment of the present invention.

### DETAILED DESCRIPTION OF EMBODIMENTS OF THE PRESENT INVENTION

The following description with reference to the accompanying drawings is provided to assist in a comprehensive understanding of various embodiments of the present invention as defined by the claims and their equivalents. Accordingly, various embodiments of the present invention are described herein to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms “include,” “comprise,” “including,” or “comprising,” used herein, indicate disclosed functions, operations, or existence of elements, but does not exclude other functions, operations or elements. It should be further understood that the terms “include”, “comprise”, “have”, “including”, “comprising”, or “having,” used herein, specify the presence of stated features, integers, operations, elements, components, or combinations thereof, but does not preclude the presence or addition of one or more other features, integers, operations, elements, components, or combinations thereof.

The terms “or” and “at least one of,” used herein, should be construed to include any combination of the words listed together with the term. For example, the expressions “A or B” and “at least one of A and/or B” may indicate A, B, or both A and B.

Terms such as “first”, “second”, and the like, used herein, may refer to various elements, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present invention, a first element may be referred to as a second element, and similarly, a second element may be referred to as a first element.

In the description below, when one component (or element, device, etc.) is referred to as being “connected” to another component (or element, device, etc.), it should be understood that the former can connected to the latter directly or via an intervening component (or element, device, etc.). It will be further understood that when one component is referred to as being “directly connected” or “directly linked” to another component, it means that no intervening component is present.

Terms used in this specification are used to describe embodiments of the present invention and are not intended to limit the scope of the present invention. The terms of a singular form may include plural forms, unless otherwise specified.

Unless otherwise defined herein, all the terms used herein, which include technical or scientific terms, should be construed as having a meaning equivalent to that generally understood by a person skilled in the art. Terms, which are defined in a dictionary and are commonly used, should be interpreted as is customarily interpreted in the relevant related art and not in an idealized or overly formal sense, unless expressly so defined herein.

Electronic devices, according to various embodiments of the present invention, may include a metal case, a plastic case, or a case constructed of any suitable material. For example, the electronic devices may include at least one of smartphones, tablet Personal Computers (PCs), mobile phones, video telephones, electronic book readers, desktop PCs, laptop PCs, netbook computers, Personal Digital Assistants (PDAs), Portable Multimedia Players (PMPs), Motion Picture Experts Group (MPEG-1 or MPEG-2) Audio Layer 3 (MP3) players, mobile medical devices, cameras, wearable devices (e.g., Head-Mounted Devices (HMDs), such as electronic glasses), electronic apparel, electronic bracelets, electronic necklaces, electronic appcessories, electronic tattoos, smart watches, and the like.

According to various embodiments of the present invention, the electronic devices may be smart home appliances including metal cases, etc. The smart home appliances may include at least one of, for example, televisions (TVs), Digital Versatile Disc (DVD) players, audio players, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, electronic picture frames, and the like.

According to various embodiments of the present invention, the electronic devices may include at least one of medical devices (e.g., a Magnetic Resonance Angiography (MRA), a Magnetic Resonance Imaging (MRI), a Computed Tomography (CT) scanners, and ultrasonic devices), navigation devices, Global Positioning System (GPS) receivers, Event Data Recorders (EDRs), Flight Data Recorders (FDRs), vehicle infotainment devices, electronic equipment for vessels (e.g., navigation systems and gyrocompasses), avionics, security devices, head units for vehicles, industrial or home robots, Automatic Teller Machines (ATMs), and Points Of Sales (POS) machines

According to various embodiments of the present invention, the electronic devices may include at least one of parts of furniture or buildings/structures having communication functions, electronic boards, electronic signature receiving devices, projectors, and measuring instruments (e.g., water meters, electricity meters, gas meters, and wave meters) including metal cases.

The electronic devices, according to various embodiments of the present invention, may be one or more combinations of the above-mentioned devices. Furthermore, the electronic devices, according to various embodiments of the present invention, may be flexible devices.

It should be obvious to those skilled in the art that the electronic devices, according to various embodiments of the present invention, are not limited to the above-mentioned devices.

Hereinafter, the present invention will be more fully described with reference to accompanying drawings. It should be noted that throughout the drawings, like reference numerals are used to depict the same or similar elements, features, and structures.

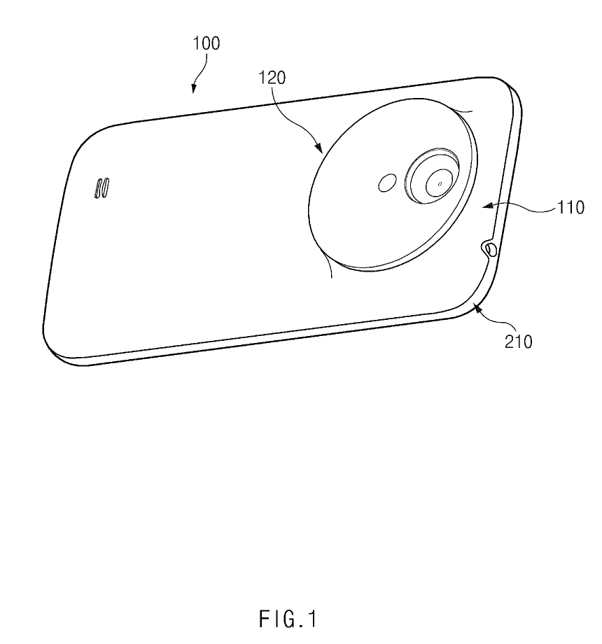

FIG. 1 is a perspective view of an electronic device including an electronic device case, according to an embodiment of the present invention.

Referring to FIG. 1, an electronic device case 100 is provided The electronic device case 100 includes a case part 110 coupled to an electronic device 210, such as a mobile phone, and a cover part 120 coupled to the case part 110 and into which a lens 123 or a filter 124 is inserted.

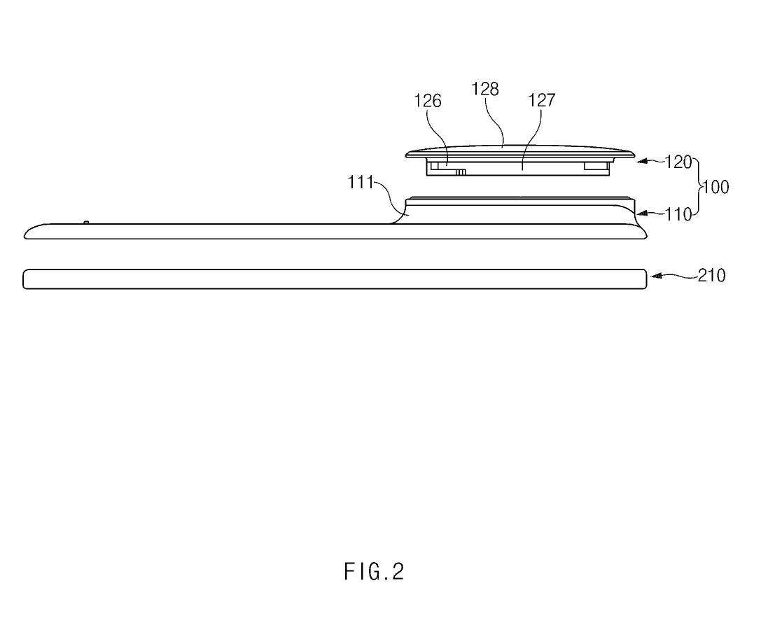

FIG. 2 is an exploded view of an electronic device including an electronic device case, according to an embodiment of the present invention.

Referring to FIG. 2, a case part 110 and a cover part 120 of an electronic device case 100 are provided. A protrusion part 111 is formed at one side of a case part 110 for connection with the cover part 120.

The protrusion part 111 protrudes from a side surface of the case part 110 and the horizontal section of the protrusion part 111 has a circular shape. The protrusion part 111 has at least one magnetic substance at a side wall thereof.

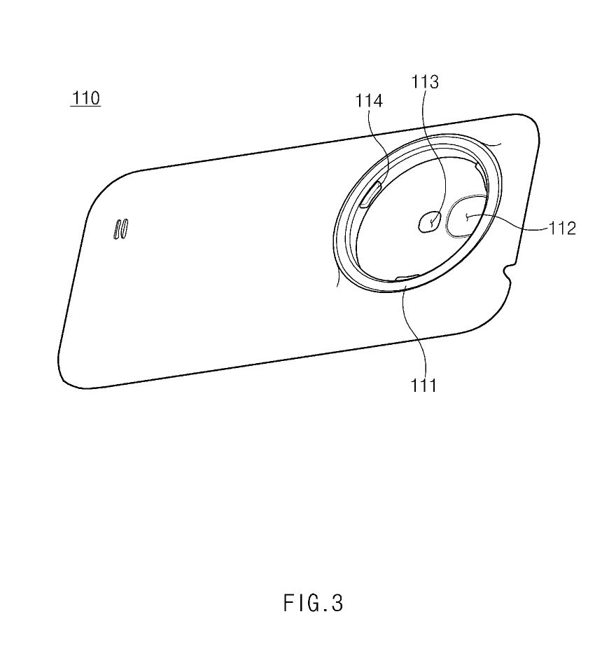

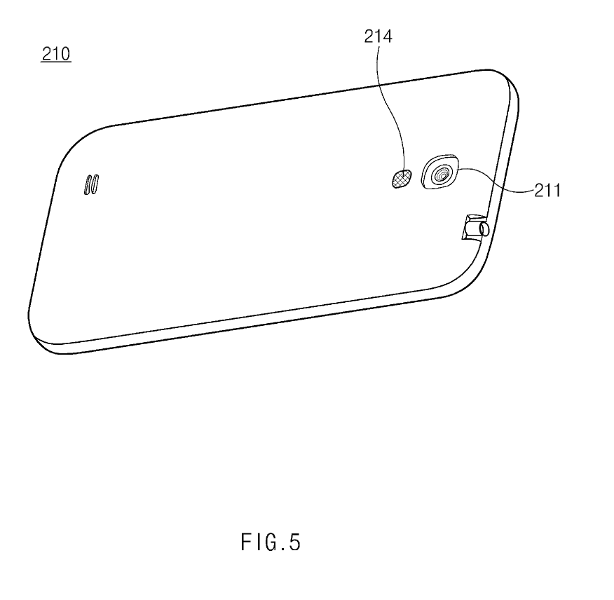

FIG. 3 is a perspective view of a case part of an electronic device case, according to an embodiment of the present invention. FIG. 5 is a perspective view of an electronic device, according to an embodiment of the present invention.

Referring to FIG. 3, a case part 110 of an electronic device case 100 is provided. The protrusion part 111 extends from a side surface of the case part 110 by a specific height and has at least one first pin 114, which protrudes toward a center direction of the protrusion part 111, and at least one first groove formed intaglio. The at least one first pin 114 and the at least one first groove may be disposed at a side wall of the protrusion part 111.

A first through-hole 112 is disposed at a position of the case part 110 inside the protrusion part 111 to expose a camera 211 of the electronic device 210, as shown in FIG. 5, for taking a picture or video.

A third through-hole 113 is disposed at a position of the case part 110 inside the protrusion part 111 to expose a flash 214, such as a Light-Emitting Diode (LED), of the electronic device 210 to allow light from the flash 214, as shown in FIG. 5, to pass through the case part 110.

The first through-hole 112 and the third through-hole 113 formed at the case part 110 inside the protrusion part 111 may be disposed at positions spaced apart from each other by a specific distance. Alternatively, the first through-hole 112 and the third through-hole 113 may be disposed such that at least portions thereof are coupled to each other.

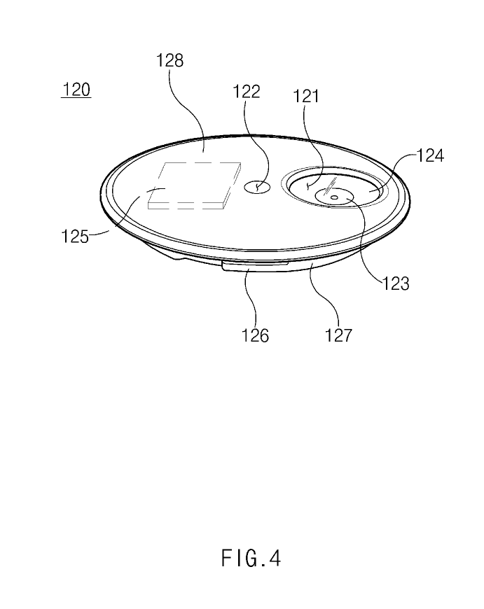

FIG. 4 is a perspective view of a cover part of an electronic case, according to an embodiment of the present invention.

Referring to FIG. 4, a cover part 120 of an electronic device case 100 is provided. The cover part 120 includes a pillar part 127 of which the horizontal section is circular, and a cover 128 formed on the top end of the pillar part 127 and having an area wider than that of a cross section of the pillar part 127

The cover part 120 includes a second through-hole 121 disposed at a position of the cover 128 corresponding to the first through-hole 112 of the case part 110, and a fourth through-hole 122 disposed at a position of the cover 128 corresponding to the third through-hole 113 of the case part 110.

Like the first through-hole 112 and the third through-hole 113, the second through-hole 121 and the fourth through-hole 122 may be disposed at positions spaced apart from each other by a specific distance. Alternatively, the second through-hole 121 and the fourth through-hole 122 may be disposed such that at least portions thereof are coupled to each other.

The pillar part 127 has a second pin 126 protruding outward from a side wall thereof and at least one second groove depressed, thereby allowing the cover part 120 to be detachably coupled to the case part 110.

Referring to FIGS. 3 and 4, the first pin 114 may be inserted into the second groove and the second pin 126 may be inserted into the first groove, thereby allowing the cover part 120 to be coupled to the case part 110.

When coupled to the case part 110, the cover part 120 may serve as a cover for the camera 211 of the electronic device 210 coupled to the case part 120, thereby protecting the camera 211 from an external impact; thereby preventing damage to the camera 211.

Referring to FIG. 4, a separate lens 123 or a filter 124 may be inserted into the second through-hole 121.

The lens 123 inserted into the second through-hole 121 may be a lens for changing a viewing angle, a macro lens, or the like. The filter 124 inserted into the second through-hole 121 may be an ultraviolet lens or filter for blocking ultraviolet light, a polarizing filter for blocking light reflected from a subject, or the like. Different kinds of filters 124, overlapping one another, may be provided at the second through-hole 121.

A Near-Field Communication (NFC) tag 125 may be disposed at one side of the cover part 120. Information about different kinds of lenses 123 or filters 124 to be inserted into the cover part 120 may be stored on the NFC tag 125. When the cover part 120 is coupled to the case part 110, the NFC tag 125 disposed at the cover part 120 may be read by the electronic device 210 coupled to the case part 110, thereby making it possible to transmit, to the electronic device 210, NFC tag information identifying the kinds of lenses or filters inserted into the cover part 120.

Here, the term “NFC” is used to indicate an example of a near field or short range communication scheme in which a specific low-frequency band (e.g., 13.56 MHz) is used. Electronic devices such as mobile phones may communicate with each other within a short distance (e.g., 10 cm). Other short range communication schemes are also contemplated.

The NFC tag 125 may be built in the cover part 120 or may be coupled to the cover part 120, with the NFC tag exposed to the outside surface of the cover part 120.

The electronic device 210 may recognize a kind of lens 123 or filter 124 when the cover part 120 equipped with the NFC tag 125, in which information of the lens 123 or the filter 124 is stored, is close to the electronic device 210.

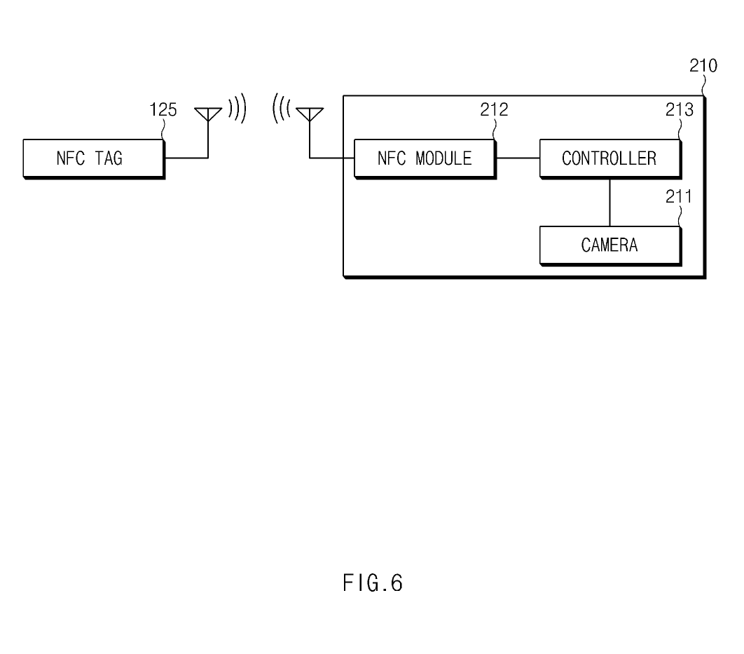

FIG. 6 is a block diagram illustrating transmission of data through an NFC tag to an electronic device, according to an embodiment of the present invention.

Referring to FIG. 6, the electronic device 210 includes a camera 211, an NFC module 212, capable of reading the NFC tag 125 disposed at a cover part 120, and a controller 213, configured to control an operation of the camera 211 in response to information read from the NFC tag 125 or to change a setting of the camera 211.

The controller 213 may automatically change a setting of the camera 211, based on information about the lens 123 or the filter 124 stored on the NFC tag 125.

For example, in the case where a lens 123 for changing a viewing angle is inserted into the cover part 120, and information associated with the lens 123 is stored on the NFC tag 125 provided at the cover part 120, when the cover part 120 and the case part 110 are coupled to each other, the NFC module 212, spaced apart from the NFC tag 125 by a specific distance, reads the NFC tag 125 to collect information stored on the NFC tag 125. The NFC module 212 provides the controller 213 with the collected information from the NFC tag 125.

The controller 213 of the electronic device 210 may change a setting of the camera 211 of the electronic device 210, based on the NFC tag information provided by the NFC module 212.

In the same manner, in the case where information about the filter 124 inserted in the cover part 120 is stored on the NFC tag 125 provided at the cover part 120, when the cover part 120 is coupled to the case part 110 of the electronic device 210, the NFC tag 125 is in close proximity to the electronic device 210, thereby allowing the NFC module 212 to read information related to the filter 124 from the NFC tag 125. The controller 213 may change a setting of the camera 211 to a predetermined value (e.g., a value for adjusting a brightness or a shooting setting) to correspond to a characteristic of the filter 124, based on information read from the NFC tag 125.

The controller 213 of the electronic device 210 may control to automatically turn on (or activate) the camera 211 when the camera 211 is in an off state or an inactive state, when the cover part 120 including a specific NFC tag is mounted and the NFC module 212 of the electronic device 210 is activated.

The controller 213 of the electronic device 210 may further adjust at least one of a control of a turn-on/turn-off operation of the camera 211 and a setting of a shooting environment (e.g., a setting of light sensitivity, a setting of an aperture value, a setting of a shutter speed, a close-up setting, a flash setting, and the like), based on a kind of lens 123 or filter 124 mounted at the cover part 120.

The electronic device 210 may further include a memory that stores different settings (e.g., an information table) of the camera 211 corresponding to different NFC tag data. When NFC tag information is collected, the controller 213 checks the information table stored at the memory to determine a setting of the camera 211 corresponding to the cover part 120 currently mounted. Based on the determined setting, the controller 213 may control an operation of the camera 211 or adjust a setting of a shooting environment of the camera 211.

As described above, it may be possible to cover a camera lens of an electronic device using a cover part. Furthermore, it may be possible to provide various effects which are difficult to implement in a camera of an electronic device by inserting a lens or a filter into a cover part attached to a case coupled to the electronic device. Also, it may be possible to automatically transmit information about a lens or filter mounted on cover part, provided with an NFC tag, to the electronic device when the cover part is coupled to a case part which is coupled to the electronic device.

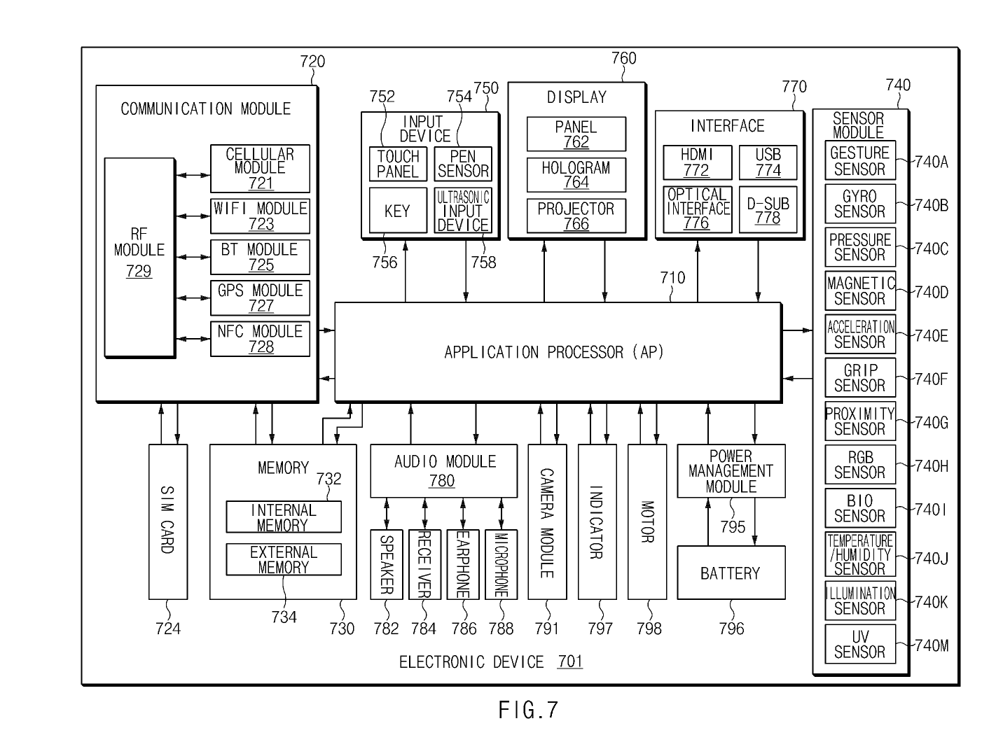

FIG. 7 is a block diagram illustrating a configuration of an electronic device, according to an embodiment of the present invention.

Referring to FIG. 7, electronic device 701 is provided. According to various embodiments an electronic device of the present invention may include a part or all of components of electronic device 701. The electronic device 701 includes one or more Application Processors (AP) 710, a communication module 720, a Subscriber Identification Module (SIM) card 724, a memory 730, a sensor module 740, an input device 750, a display 760, an interface 770, an audio module 780, a camera module 791, a power management module 795, a battery 796, an indicator 797, and a motor 798.

The AP 710 drives an Operating System (OS) or an application to control a plurality of hardware or software components connected to the AP 710 and processes a variety of data, including multimedia data.

The AP 710 may be implemented with a System on Chip (SoC), for example.

The AP 710 may further include a Graphics Processing Unit (GPU).

The communication module 720 transmits and receives data when communication is conveyed between other electronic devices connected with the electronic device 701 through a network. The communication module 720 includes a cellular module 721, a Wi-Fi module 723, a Bluetooth (BT) module 725, a Global Positioning System (GPS) module 727, a Near Field Communication (NFC) module 728, and a Radio Frequency (RF) module 729.

The cellular module 721 provides voice communication, video communication, a text service, an Internet service, and the like through a communication network (e.g., Long Term Evolution (LTE), LTE-A, Code Division Multiple Access (CDMA), Wideband CDMA (WCDMA), Universal Mobile Telecommunication System (UMTS), Wireless Broadband (WiBro), and Global System for Mobile communication (GSM), or the like). The cellular module 721 additionally performs authentication of an electronic device within a communication network using a a SIM card 724, for example. The cellular module 721 may perform at least a portion of functions that the AP 710 provides. For example, the cellular module 721 may perform at least a portion of a multimedia control function.

The cellular module 721 may include a Communications Processor (CP). Furthermore, the cellular module 721 may be implemented with a SoC.

The AP 710 or the cellular module 721 (e.g., a communication processor) may load and process an instruction or data, received from nonvolatile memories respectively connected thereto, or from at least one of other elements connected to the AP 710 or the cellular module 721. Also, the AP 710 or the cellular module 721 may store, in the nonvolatile memory, data received from or generated by at least one of the other elements.

Each of the Wi-Fi module 723, the BT module 725, the GPS module 727, and the NFC module 728 may include a processor for processing data exchanged through a corresponding module.

At least a portion (e.g., two or more components) of the cellular module 721, the Wi-Fi module 723, the BT module 725, the GPS module 727, and the NFC module 728 may be included within one Integrated Circuit (IC) or an IC package. For example, at least a portion (e.g., a communication processor corresponding to the cellular module 721 and a Wi-Fi processor corresponding to the Wi-Fi module 723) of communication processors corresponding to the cellular module 721, the Wi-Fi module 723, the BT module 725, the GPS module 727, and the NFC module 728 may be implemented with one SoC.

The RF module 729 transmits and receives an RF signal. The RF module 729 may include a transceiver, a Power Amplifier Module (PAM), a frequency filter, or Low Noise Amplifier (LNA). Furthermore, the RF module 729 may further include a conductor or a conducting wire for transmitting and receiving an electromagnetic wave in a space in wireless communication.

At least one of the cellular module 721, the Wi-Fi module 723, the BT module 725, the GPS module 727, or the NFC module 728 may transmit and receive an RF signal through a separate RF module.

The SIM card 724 is a card that includes a SIM and is inserted to a slot formed at a specific position of the electronic device 701. The SIM card 724 includes unique identify information (e.g., Integrated Circuit Card Identifier (ICCID)) or subscriber information (e.g., Integrated Mobile Subscriber Identity (IMSI)).

The memory 730 includes an internal memory 732 or an external memory 734.

The internal memory 732 may include at least one of a volatile memory (e.g., a Dynamic Random Access Memory (DRAM), a Static RAM (SRAM), a Synchronous DRAM (SDRAM)), and a nonvolatile memory (e.g., a One-Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, or a NOR flash memory).

The internal memory 732 may be a Solid State Drive (SSD).

The external memory 734 includes a flash drive, for example, Compact Flash (CF), Secure Digital (SD), Micro Secure Digital (Micro-SD), Mini Secure Digital (Mini-SD), extreme Digital (xD), or a memory stick. The external memory 734 is functionally connected with the electronic device 701 through various interfaces.

The electronic device 701 may further include a storage device (or storage medium), such as a hard disk drive.

The sensor module 740 measures a physical quantity or detects an operation state of the electronic device 701, and converts the measured or detected information to an electric signal. The sensor module 740 may include at least one of a gesture sensor 740A, a gyro sensor 740B, a pressure sensor 740C, a magnetic sensor 740D, an acceleration sensor 740E, a grip sensor 740F, a proximity sensor 740G, a color sensor 740H (e.g., Red, Green, Blue (RGB) sensor), a biometric sensor 740I, a temperature/humidity sensor 740J, an illumination sensor 740K, or an ultraviolet (UV) sensor 740M. Additionally, the sensor module 740 may further include, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 740 may further include a control circuit for controlling at least one or more sensors included therein.

The input device 750 includes a touch panel 752, a (digital) pen sensor 754, a key 756, or an ultrasonic input unit 758.

The touch panel 752 recognizes a touch input using at least one of capacitive, resistive, infrared and ultrasonic detecting methods. Also, the touch panel 752 may further include a control circuit. In the case of using the capacitive detecting method, a physical contact or proximity recognition is possible. The touch panel 752 may further include a tactile layer. In this case, the touch panel 752 may provide a tactile reaction to a user.

The (digital) pen sensor 754 may be implemented in a similar or same manner as the method of receiving a touch input of a user or may be implemented using an additional sheet for recognition.

The key 756 may include, for example, a physical button, an optical key, or a keypad.

The ultrasonic input device 758, which is an input device for generating an ultrasonic signal, enables the electronic device 701 to sense or detect a sound wave through a microphone (e.g., a microphone 788) to identify data, wherein the ultrasonic input device 758 is capable of wireless recognition.

The electronic device 701 may use the communication module 720 to receive a user input from an external device (e.g., a computer or server) connected to the communication module 720.

The display module 760 may include a panel 762, a hologram device 764, or a projector 766.

The panel 762 may be a Liquid Crystal Display (LCD) or an Active-Matrix Organic Light-Emitting Diode (AMOLED). The panel 764 may be flexible, transparent or wearable. The panel 764 and the touch panel 752 may be integrated into a single module.

The hologram device 764 displays a stereoscopic image in the air using light interference.

The projector 766 projects light onto a screen to display an image. The screen may be arranged in the inside or the outside of the electronic device 701.

The display module 760 may further include a control circuit for controlling the panel 762, the hologram device 764, or the projector 766.

The interface 770 may include, for example, a High-Definition Multimedia Interface (HDMI) 772, a Universal Serial Bus (USB) 774, an optical interface 776, or a D-subminiature (D-sub) 778. Additionally, the interface 770 may include, for example, a Mobile High Definition Link (MHL) interface, a SD card/Multi-Media Card (MMC) interface, or an Infrared Data Association (IrDA) standard interface.

The audio module 780 converts a sound and an electric signal in dual directions. The audio module 780 processes sound information that is input or output through a speaker 782, a receiver 784, an earphone 786, or a microphone 788.

The camera module 791, for shooting a still image or a video, may include at least one image sensor (e.g., a front sensor or a rear sensor), a lens, an Image Signal Processor (ISP), or a flash (e.g., an LED or a xenon lamp).

The power management module 795 manages power of the electronic device 701. The power management module 795 may include a Power Management Integrated Circuit (PMIC) a charger IC, or a battery gauge.

The PMIC may be mounted on an integrated circuit or a SoC semiconductor.

A charging method may be classified into a wired charging method and a wireless charging method. The charger IC charges a battery, and prevents an overvoltage or an overcurrent from being introduced from a charger. The charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier, and the like.

The battery gauge measures, for example, a remaining capacity of the battery 796 and a voltage, current or temperature thereof while the battery is charged. The battery 796 stores or generates electricity, and supplies power to the electronic device 701 using the stored or generated electricity. The battery 796 may include, for example, a rechargeable battery or a solar battery.

The indicator 797 displays a specific state of the electronic device 701 or a part thereof (e.g., the AP 710), such as a booting state, a message state, a charging state, and the like.

The motor 798 converts an electrical signal into a mechanical vibration.

A processing device (e.g., a GPU) for supporting a mobile TV may be included in the electronic device 701. The processing device for supporting a mobile TV may process media data according to the standards of Digital Multimedia Broadcasting (DMB), Digital Video Broadcasting (DVB), or media flow.

According to various embodiments of the present invention, each of the above-mentioned elements of the electronic device may be configured with one or more components, and the names of the elements may be changed according to the type of the electronic device. The electronic device may include at least one of the above-mentioned elements, and some elements may be omitted or other additional elements may be added. Furthermore, some of the elements of the electronic device, according to various embodiments of the present invention, may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an Application-Specific IC (ASIC) chip, a Field-Programmable Gate Array (FPGA), and a programmable-logic device for performing some operations, which are known or will be developed.

At least a portion of an apparatus (e.g., modules or functions thereof) or a method (e.g., operations), according to various embodiments of the present invention, may be implemented by instructions stored in a computer-readable storage media in the form of a programmable module. The instruction, when executed by one or more processors, may cause the one or more processors to perform a function corresponding to the instruction. At least a portion of the programming module may include the following for performing one or more functions: a module, a program, a routine, sets of instructions, or a process.

A computer-readable recording medium may include a hard disk, a magnetic media such as a floppy disk and a magnetic tape, an optical media such as Compact Disc Read Only Memory (CD-ROM) and a Digital Versatile Disc (DVD), a magneto-optical media, such as a floptical disk, and hardware devices specifically configured to store and perform a program instruction (e.g., a programming module), such as Read Only Memory (ROM), Random Access Memory (RAM), and a flash memory. Also, a program instruction may include, not only a mechanical code such as code generated by a compiler, but also a high-level language code executable on a computer using an interpreter. The above hardware unit may be configured to operate via one or more software modules for performing an operation of the present invention, and vice versa.

A module or a programming module, according to an embodiment of the present invention, may include at least one of the above elements, or a portion of the above elements may be omitted, or additional other elements may be further included. Operations performed by a module, a programming module, or other elements may be executed sequentially, in parallel, repeatedly, or in a heuristic method. Also, a portion of operations may be executed in different sequences, omitted, or other operations may be added.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. An electronic device case comprising:
a case part including a protrusion part protruding from one side thereof and a first through-hole through which a camera lens is exposed and which is disposed in the protrusion part; and
a cover part detachably coupled to the protrusion part, the cover part including a second through-hole disposed at a position corresponding to the first through-hole,
wherein at least one of a lens and a filter is inserted into the second through-hole.

2. The electronic device case of claim 1, wherein the protrusion part has a shape of which a horizontal section is circular.

3. The electronic device case of claim 1, wherein the protrusion part comprises at least one magnetic substance at a side wall thereof.

4. The electronic device case of claim 1, wherein the case part further comprises a third through-hole disposed at a position where a flash of an electronic device is exposed, and
wherein the cover part further comprises a fourth through-hole disposed at a position corresponding to the third through-hole.

5. The electronic device case of claim 4, wherein the first through-hole and the third through-hole of the case part are disposed at positions spaced apart from each other by a specific distance.

6. The electronic device case of claim 4, wherein at least portions of the first through-hole and the third through-hole of the case part are disposed so as to be connected to each other.

7. The electronic device case of claim 1, wherein the protrusion part extends from one side surface of the case part by a specific distance, and
wherein the protrusion part comprises at least one first pin, protruding toward a center direction from a side wall thereof, and at least one first groove.

8. The electronic device case of claim 1, wherein the cover part comprises:
a pillar part of which a horizontal section is circular; and
a cover formed on the top end of the pillar part and having an area wider than that of a cross section of the pillar part.

9. The electronic device case of claim 8, wherein the pillar part comprises a second pin, protruding from a side wall of the pillar part to one side thereof and at least one second groove which is depressed.

10. The electronic device case of claim 1, wherein the cover part further comprises a Near Field Communication (NFC) tag.

11. The electronic device case of claim 10, wherein the NFC tag is built into the cover part or attached to an exposed surface of the cover part.

12. The electronic device case of claim 11, wherein information related to at least one of a kind of lens and a kind of filter inserted into the cover part is stored on the NFC tag.

13. An electronic device comprising:
an electronic device case comprising:
a case part including a protrusion part protruding from one side thereof and a first through-hole through which a camera lens is exposed and which is disposed in the protrusion part, and
a cover part detachably coupled to the protrusion part, the cover part including a second through-hole disposed at a position corresponding to the first through-hole,
wherein at least one of a lens and a filter is inserted into the second through-hole;
a camera;
an NFC module configured to read the NFC tag when connected to the electronic device case; and
a control part configured to control an operation of the camera in response to the NFC tag information.

14. The electronic device of claim 13, wherein the cover part further comprises a Near Field Communication (NFC) tag.

15. The electronic device case of claim 14, wherein the NFC tag is built into the cover part or attached to an exposed surface of the cover part.

16. The electronic device case of claim 15, wherein information related to at least one of a kind of lens and a kind of filter inserted into the cover part is stored on the NFC tag.

17. The electronic device of claim 16, wherein when the cover part is coupled to the case part, the control part automatically adjusts a setting of a camera shooting environment of the camera, based the NFC tag information.

18. The electronic device of claim 13, wherein a viewing angle change lens is inserted into the cover part, and
wherein the control part automatically adjusts a focus of the camera, based on an angle of view of the camera.
